(19) United States
(12) Patent Application Publication
(10) Pub. No.: US 2023/0245364 A1
(43) Pub. Date: Aug. 3, 2023

(54) Method for Processing Video, Electronic Device, and Storage Medium

(71) Applicant: Beijing Baidu Netcom Science Technology Co., Ltd., Beijing (CN)

(72) Inventors: Guanying CHEN, Beijing (CN); Zhikang ZOU, Beijing (CN); Xiaoqing YE, Beijing (CN); Hao SUN, Beijing (CN)

(73) Assignee: Beijing Baidu Netcom Science Technology Co., Ltd., Beijing (CN)

(21) Appl. No.: 17/884,231

(22) Filed: Aug. 9, 2022

(30) Foreign Application Priority Data
Jan. 28, 2022 (CN) 202210108853.1

(51) Int. Cl. G06T 13/20; G06T 7/20; G06T 7/80

(52) U.S. Cl. CPC G06T 13/20; G06T 7/20; G06T 7/80; G06T 2207/30241

(57) ABSTRACT

The present disclosure provides a method for processing a video, an electronic device, and a storage medium. A specific implementation solution includes: generating a first three-dimensional movement trajectory of a virtual three-dimensional model in world space based on attribute information of a target contact surface of the virtual three-dimensional model in the world space; converting the first three-dimensional movement trajectory into a second three-dimensional movement trajectory in camera space, where the camera space is three-dimensional space for shooting an initial video; determining a movement sequence of the virtual three-dimensional model in the camera space according to the second three-dimensional movement trajectory; and compositing the virtual three-dimensional model and the initial video by means of texture information of the virtual three-dimensional model and the movement sequence, to obtain a to-be-played target video.

### CROSS-REFERENCE TO RELATED APPLICATIONS

The present disclosure claims priority of Chinese Patent Application No. 202210108853.1, filed to China Patent Office on Jan. 28, 2022. Contents of the present disclosure are hereby incorporated by reference in entirety of the Chinese Patent Application.

### TECHNICAL FIELD

The present disclosure relates to the field of artificial intelligence, specifically to computer vision and deep learning technologies, may specifically be applied in a three-dimensional visual scene, and in particular, relates to a method for processing a video, an electronic device, and a storage medium.

### BACKGROUND OF THE INVENTION

During live streaming, it often happens that audiences give gifts to anchors. After the gifts are delivered, a display effect in a live video interface directly affects watching experience of the audiences. In view of this, those skilled in the art constantly experiment with the gift display effects in various live streaming.

In an existing solution, gifts that are delivered by the audiences during live streaming are two-dimensional gifts. When the anchors receive the gifts during live streaming, the gifts are rendered as a gift sequence, and the gift sequence is superimposed with an input video of the live streaming, so that a video effect that the two-dimensional gifts fall from the top of a screen to the bottom of the screen can be shown.

### SUMMARY OF THE INVENTION

At least some embodiments of the present disclosure provide a method for processing a video, an electronic device, and a storage medium, so as at least to partially solve the technical problem that two-dimensional live streaming gifts cannot interact with a live streaming scene, resulting in unreal gift effects and poor watching experience of the audiences in the related art.

In an embodiment of the present disclosure, a method for processing a video is provided, including: generating a first three-dimensional movement trajectory of a virtual three-dimensional model in world space based on attribute information of a target contact surface of the virtual three-dimensional model in the world space; converting the first three-dimensional movement trajectory into a second three-dimensional movement trajectory in camera space, where the camera space is three-dimensional space for shooting an initial video; determining a movement sequence of the virtual three-dimensional model in the camera space according to the second three-dimensional movement trajectory; and compositing the virtual three-dimensional model and the initial video by means of texture information of the virtual three-dimensional model and the movement sequence, to obtain a to-be-played target video.

In another embodiment of the present disclosure, an electronic device is further provided. The electronic device includes at least one processor and a memory communicatively connected with the at least one processor. The memory is configured to store at least one instruction executable by the at least one processor. The at least one instruction is performed by the at least one processor, to cause the at least one processor to perform the method for processing the video mentioned above.

In another embodiment of the present disclosure, a non-transitory computer-readable storage medium storing at least one computer instruction is further provided. The at least one computer instruction is used for a computer to perform the method for processing the video mentioned above.

In another embodiment of the present disclosure, a computer program product is further provided. The computer program product includes a computer program. The method for processing the video mentioned above is implemented when the computer program is performed by a processor.

According to the method in the embodiments of the present disclosure, the first three-dimensional movement trajectory of a virtual three-dimensional model in world space is generated based on attribute information of a target contact surface of the virtual three-dimensional model in the world space. The first three-dimensional movement trajectory is converted into the second three-dimensional movement trajectory in camera space. The camera space is three-dimensional space for shooting an initial video. The movement sequence of the virtual three-dimensional model in the camera space is determined according to the second three-dimensional movement trajectory. The virtual three-dimensional model and the initial video are composited by means of texture information of the virtual three-dimensional model and the movement sequence, to obtain the to-be-played target video. Therefore, the purpose of achieving interaction between three-dimensional gifts and a live streaming scene during live streaming can be achieved, and the technical effect of improving a gift display effect and audience watching experience by means of a special effect of live streaming three-dimensional gifts, thereby solving the technical problem that two-dimensional live streaming gifts cannot interact with a live streaming scene, resulting in unreal gift effects and poor watching experience of the audiences in the related art.

It is to be understood that, the content described in this section is not intended to identify the key or important features of the embodiments of the present disclosure, nor is it intended to limit the scope of the present disclosure. Other features of the present disclosure will become easy to understand through the following description.

### BRIEF DESCRIPTION OF THE SEVERAL VIEWS OF THE DRAWINGS

Drawings are used for better understanding the solution, and are not intended to limit the present disclosure.

FIG. 1 is a block diagram of a hardware structure of a computer terminal (or a mobile device) configured to implement a method for processing a video according to an embodiment of the present disclosure.

FIG. 2 is a flowchart of a method for processing a video according to an embodiment of the present disclosure.

FIG. 3 is a schematic diagram of an optional live streaming user interface according to an embodiment of the present disclosure.

FIG. 4 is a schematic diagram of an optional special three-dimensional gift effect during live streaming according to an embodiment of the present disclosure.

FIG. 5 is a structural block diagram of an apparatus for processing a video according to an embodiment of the present disclosure.

### DETAILED DESCRIPTION OF THE INVENTION

Exemplary embodiments of the present disclosure are described in detail below with reference to the drawings, including various details of the embodiments of the present disclosure to facilitate understanding, and should be regarded as exemplary. Thus, those of ordinary skilled in the art shall understand that, variations and modifications can be made on the embodiments described herein, without departing from the scope and spirit of the present disclosure. Likewise, for clarity and conciseness, descriptions of well-known functions and structures are omitted in the following description.

It is to be noted that terms “first”, “second” and the like in the description, claims and the above-mentioned drawings of the present disclosure are used for distinguishing similar objects rather than describing a specific sequence or a precedence order. It should be understood that the data applied in such a way may be exchanged where appropriate, in order that the embodiments of the present disclosure described here can be implemented in an order other than those illustrated or described herein. In addition, terms “include” and “have” and any variations thereof are intended to cover non-exclusive inclusions. For example, it is not limited for processes, methods, systems, products or devices containing a series of steps or units to clearly list those steps or units, and other steps or units which are not clearly listed or are inherent to these processes, methods, products or devices may be included instead.

An embodiment of the present disclosure provides a method for processing a video. It is to be noted that the steps shown in the flow diagram of the accompanying drawings may be executed in a computer system, such as a set of computer-executable instructions, and although a logical sequence is shown in the flow diagram, in some cases, the steps shown or described may be executed in a different order than here.

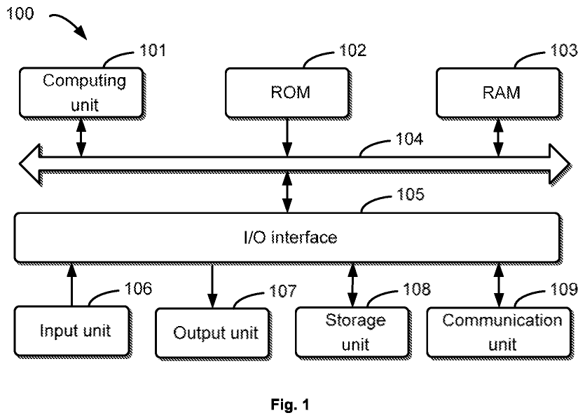

The method embodiment provided in this embodiment of the present disclosure may be performed in a mobile terminal, a computer terminal, or a similar electronic device. The electronic device is intended to represent various forms of digital computers, such as laptop computers, desktop computers, workbenches, personal digital assistants, servers, blade servers, mainframe computers, and other suitable computers. The electronic device may also express various forms of mobile devices, such as personal digital processing, cellular phones, smart phones, wearable devices, and other similar computing devices. The components shown herein, connections and relationships of the components, and functions of the components are examples, and are not intended to limit the implementation of the present disclosure described and/or required herein. FIG. 1 is a block diagram of a hardware structure of a computer terminal (or a mobile device) configured to implement a method for processing a video according to an embodiment of the present disclosure.

As shown in FIG. 1, the computer terminal 100 includes a computing unit 101. The computing unit may perform various appropriate actions and processing operations according to a computer program stored in a Read-Only Memory (ROM) 102 or a computer program loaded from a storage unit 108 into a Random Access Memory (RAM) 103. In the RAM 103, various programs and data required for the operation of the computer terminal 100 may also be stored. The computing unit 101, the ROM 102, and the RAM 103 are connected with each other according to a bus 104. An Input/Output (I/O) interface 105 is also connected with the bus 104.

Multiple components in the computer terminal 100 are connected with the I/O interface 105, and include: an input unit 106, such as a keyboard and a mouse; an output unit 107, such as various types of displays and loudspeakers; the storage unit 108, such as a disk and an optical disc; and a communication unit 109, such as a network card, a modem, and a wireless communication transceiver. The communication unit 109 allows the computer terminal 100 to exchange information/data with other devices through a computer network, such as the Internet, and/or various telecommunication networks.

The computing unit 101 may be various general and/or special processing assemblies with processing and computing capabilities. Some examples of the computing unit 101 include, but are not limited to, a Central Processing Unit (CPU), a Graphics Processing Unit (GPU), various dedicated Artificial Intelligence (AI) computing chips, various computing units for running machine learning model algorithms, a Digital Signal Processor (DSP), and any appropriate processors, controllers, microcontrollers, and the like. The computing unit 101 performs the method for processing a video described here. For example, in some embodiments, the method for processing a video may be implemented as a computer software program, which is tangibly included in a machine-readable medium, such as the storage unit 108. In some embodiments, part or all of the computer programs may be loaded and/or installed on the computer terminal 100 via the ROM 102 and/or the communication unit 109. When the computer program is loaded into the RAM 103 and performed by the computing unit 101, at least one step of the method for processing a video described here may be performed. Alternatively, in other embodiments, the computing unit 101 may be configured to perform the method for processing a video in any other suitable manners (for example, by means of firmware).

Various implementations of systems and technologies described here may be implemented in a digital electronic circuit system, an integrated circuit system, a Field Programmable Gate Array (FPGA), an Application-Specific Integrated Circuit (ASIC), an Application-Specific Standard Product (ASSP), a System-On-Chip (SOC), a Load Programmable Logic Device (CPLD), computer hardware, firmware, software, and/or a combination thereof. These various implementations may include: being implemented in at least one computer program, the at least one computer program may be performed and/or interpreted on a programmable system including at least one programmable processor. The programmable processor may be a dedicated or general programmable processor, which can receive data and instructions from a storage system, at least one input device, and at least one output device, and transmit the data and instructions to the storage system, the at least one input device, and the at least one output device.

It is noted herein that, in some optional embodiments, the electronic device shown in FIG. 1 may include a hardware element (including a circuit), a software element (including a computer code stored on the computer-readable medium), or a combination of the hardware element and the software element. It should be noted that, FIG. 1 is an example of a specific example, and is intended to illustrate the types of components that may be present in the above electronic device.

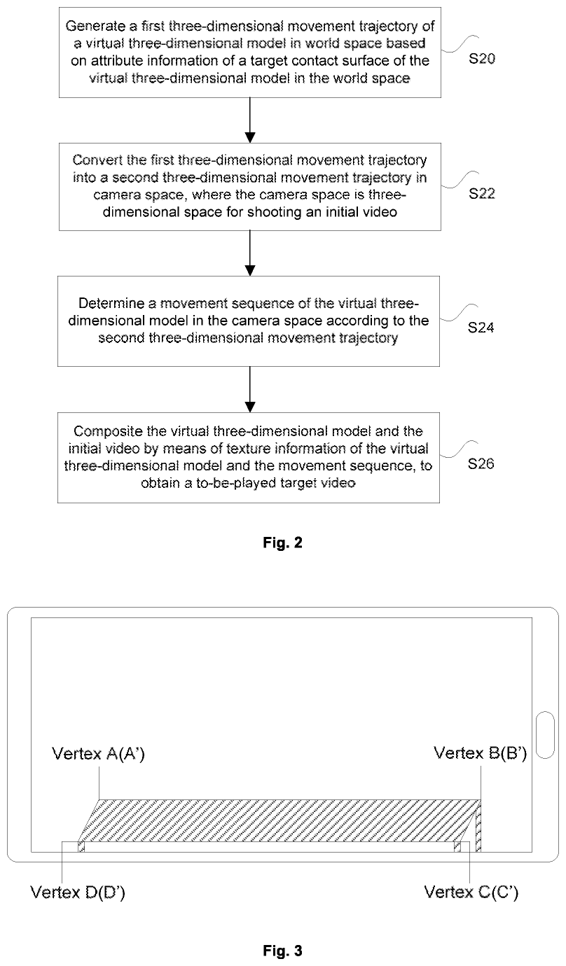

Under the above operation environment, the present disclosure provides the method for processing a video shown in FIG. 2. The method may be performed by the computer terminal shown in FIG. 1 or a similar electronic device. FIG. 2 is a flowchart of a method for processing a video according to an embodiment of the present disclosure. As shown in FIG. 2, the method may include the following steps.

At step S20, a first three-dimensional movement trajectory of a virtual three-dimensional model in world space is generated based on attribute information of a target contact surface of the virtual three-dimensional model in the world space.

The virtual three-dimensional model may be a three-dimensional gift model in live streaming. In practical application, the three-dimensional gift model is often a cartoon image of a real object, such as a lucky bag, a rose, a duck, a yacht, a plane, a rocket and so on. The three-dimensional gift model further has texture information and quality information.

The target contact surface may be a contact surface actually in the world space. In practical application, the contact surface may be a table surface, the ground, and a human body surface in a live streaming scene.

The first three-dimensional movement trajectory of the virtual three-dimensional model in the world space may be generated based on the attribute information of the target contact surface of the virtual three-dimensional model in the world space. The first three-dimensional movement trajectory may be a three-dimensional movement trajectory that is generated by means of interaction between the virtual three-dimensional model and the target contact surface.

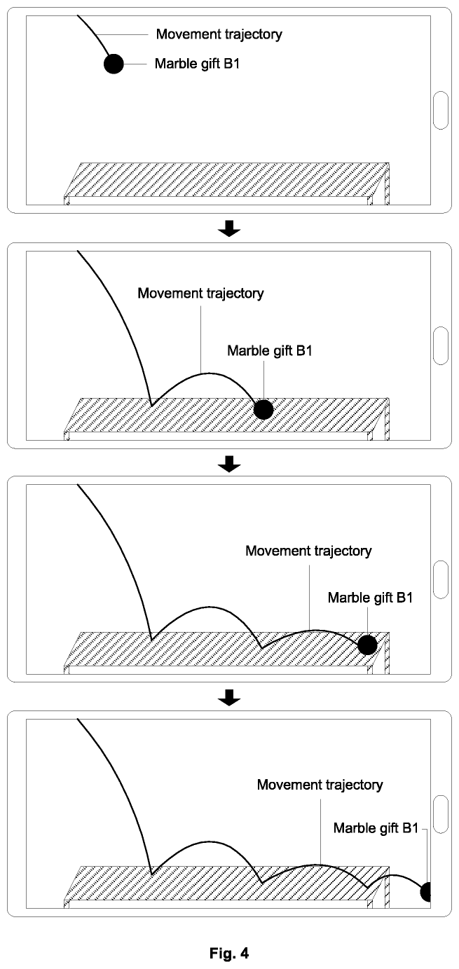

FIG. 3 is a schematic diagram of an optional live streaming user interface according to an embodiment of the present disclosure. As shown in FIG. 3, taking a live streaming as an example, the live streaming is recorded as Live1. A scene of Live1 includes a table with a table surface being a rectangle, and the table surface is used as the target contact surface and recorded as table1.

FIG. 4 is a schematic diagram of an optional special three-dimensional gift effect during live streaming according to an embodiment of the present disclosure. As shown in FIG. 4, in the live streaming Live1, three-dimensional effect display of a marble gift B1 delivered by an audience is taken as an example. A world space coordinate system Xworld(x, y, z) is predefined, where an xOy plane is a horizontal plane, and a z-axis is straight up. According to quality information and location information of the marble gift B1, and location information of the table surface table1 in the world space coordinate system, the three-dimensional movement trajectory of the marble gift B1 in the world space may be generated and recorded as Tworld.

At step S22, the first three-dimensional movement trajectory is converted into a second three-dimensional movement trajectory in camera space. The camera space is three-dimensional space for shooting an initial video.

The camera space may be the three-dimensional space for shooting the initial video based on a camera. The first three-dimensional movement trajectory is the three-dimensional movement trajectory of the virtual three-dimensional model in the world space. The second three-dimensional movement trajectory is a three-dimensional movement trajectory of the virtual three-dimensional model in the camera space.

Optionally, each location in the world space may be described according to a coordinate system taking the ground as a reference. Each location in the camera space may be described according to a coordinate system taking the camera shooting the initial video as an original point.

Still as shown in FIG. 4, in the live streaming Live1, three-dimensional effect display of a marble gift B1 delivered by an audience is taken as an example. Based on a camera used to shoot a live streaming video in Live1, a camera space coordinate system Xcamera(x′, y′, z′) is predefined. The three-dimensional movement trajectory Tworld of the marble gift B1 in the world space may be converted into the camera space, and the three-dimensional movement trajectory of the marble gift B1 in the camera space is recorded as Tcamera.

At step S24, a movement sequence of the virtual three-dimensional model in the camera space is determined according to the second three-dimensional movement trajectory.

The movement sequence of the virtual three-dimensional model in the camera space may be determined according to the second three-dimensional movement trajectory. The movement sequence refers to timing sequence movement signal data during movement of the virtual three-dimensional model, and may include location information of the virtual three-dimensional model corresponding to different moments.

Still as shown in FIG. 4, in the live streaming Live1, three-dimensional effect display of a marble gift B1 delivered by an audience is taken as an example. By means of the three-dimensional movement trajectory of the marble gift B1 in the camera space being recorded as Tcamera, the movement sequence of the marble gift B1 in the camera space may be determined and recorded as Mcamera.

At step S26, the virtual three-dimensional model and the initial video are composited by means of texture information of the virtual three-dimensional model and the movement sequence, to obtain a to-be-played target video.

The texture information of the virtual three-dimensional model may include surface texture of the virtual three-dimensional model. The surface texture not only includes grooves that cause a surface of the virtual three-dimensional model to be uneven, but also includes a color pattern on the smooth surface of the virtual three-dimensional model.

The virtual three-dimensional model and the initial video shot by the camera may be composited by means of the texture information of the virtual three-dimensional model and the movement sequence to obtain to-be-played target video. The to-be-played target video is a video including a three-dimensional movement effect of the virtual three-dimensional model.

Still as shown in FIG. 4, in the live streaming Live1, three-dimensional effect display of a marble gift B1 delivered by an audience is taken as an example. The texture information U of the marble gift B1 and the initial video Videoshot by the live streaming camera are acquired from the background of live streaming. The movement sequence of the marble gift B1 and the initial video Video may be composited according to the texture information U and the movement sequence Mcamera of the marble gift B1 in the camera space, to obtain a video #Video configured to be played for the audiences. #Video is a live streaming video including the three-dimensional movement effect of the marble gift B1.

According to the method for processing a video in this embodiment of the present disclosure, a three-dimensional effect of the virtual three-dimensional model in a video scene may be provided. An application scene in this embodiment of the present disclosure includes, but is not limited to, a three-dimensional gift effect in the living streaming scene, Virtual Reality (VR), Augmented Reality (AR), and the like.

According to step S20 to step S26 in the present disclosure, the first three-dimensional movement trajectory of the virtual three-dimensional model in the world space is generated based on the attribute information of the target contact surface of the virtual three-dimensional model in the world space. The first three-dimensional movement trajectory is converted into the second three-dimensional movement trajectory in the camera space. The camera space is three-dimensional space for shooting the initial video. The movement sequence of the virtual three-dimensional model in the camera space is determined according to the second three-dimensional movement trajectory. The virtual three-dimensional model and the initial video are composited by means of the texture information of the virtual three-dimensional model and the movement sequence, to obtain the to-be-played target video. Therefore, the purpose of achieving interaction between three-dimensional gifts and a live streaming scene during live streaming can be achieved, and the technical effect of improving a gift display effect and audience watching experience by means of a special effect of live streaming three-dimensional gifts, thereby solving the technical problem that two-dimensional live streaming gifts cannot interact with a live streaming scene, resulting in unreal gift effects and poor watching experience of the audiences in the related art.

The above method of this embodiment is further described in detail below.

As an optional implementation, in step S20, an operation of generating the first three-dimensional movement trajectory based on the attribute information of the target contact surface includes the following steps.

At step S201, location information of the target contact surface in the world space is determined according to world coordinates of multiple first vertexes on the target contact surface in the world space.

At step S202, the first three-dimensional movement trajectory is generated based on the location information and quality information of the virtual three-dimensional model.

The multiple first vertexes may be vertexes of an area corresponding to the target contact surface in the world space. In a coordinate system in the world space, the multiple first vertexes correspond to multiple world coordinates. The location information of the target contact surface in the world space may be determined according to the world coordinates of the multiple first vertexes on the target contact surface in the world space.

The virtual three-dimensional model has the quality information. The first three-dimensional movement trajectory may be generated based on the location information of the target contact surface in the world space and the quality information of the virtual three-dimensional model. The first three-dimensional movement trajectory is the three-dimensional movement trajectory of the virtual three-dimensional model in the world space.

As an optional implementation, in step S202, an operation of generating the first three-dimensional movement trajectory based on the location information and the quality information of the virtual three-dimensional model includes the following steps.

At step S2021, an initial location of the virtual three-dimensional model in the world space is configured based on the location information and the quality information of the virtual three-dimensional model.

At step S2022, the first three-dimensional movement trajectory formed by the virtual three-dimensional model falling from the initial location to the target contact surface and rebounding under the reaction force of the target contact surface is acquired through a preset physics engine.

Through acquiring the location information of the target contact surface in the world space and the quality information of the virtual three-dimensional model, an initial location of the virtual three-dimensional model in the world space may be configured. The initial location may be a location coordinate of the virtual three-dimensional model in the coordinate system in the world space.

The preset physics engine may be configured to calculate the first three-dimensional movement trajectory according to the interaction between the virtual three-dimensional model and the target contact surface. The first three-dimensional movement trajectory is formed by the virtual three-dimensional model falling from the initial location in the world space to the target contact surface and rebounding under the reaction force of the target contact surface.

Still as shown in FIG. 3, in the live streaming Live1, four vertexes of the rectangular table surface Live1 in the world space are respectively recorded as A, B, C, and D. The corresponding world coordinates are A(xa, ya, za), B(xb, yb, zb), C(xc, yc, zc), D(xd, yd, zd).

Still as shown in FIG. 4, in the live streaming Live1, three-dimensional effect display of a marble gift B1 delivered by an audience is taken as an example. The three-dimensional movement trajectory Tworld of the marble gift B1 in the world space may be generated based on the world coordinates of the four vertexes and the quality information of the marble gift B1.

Specifically, a process of acquiring the three-dimensional movement trajectory Tworld includes the following steps. An initial location P0 of the marble gift B1 is configured in the world space based on the world coordinates of the four vertexes and the quality information of the marble gift B1. The three-dimensional movement trajectory Tworld of the marble gift B1 in the world space is calculated through the physics engine. The three-dimensional movement trajectory Tworld is a trajectory that the marble gift B1 falls from the initial location P0 to the table surface table1 and finally bounces out of a graphical user interface through multiple collisions and multiple bounces.

Optionally, the physics engine may be a bullet module (pybullet). The pybullet is an easy-to-use Python module, and may be used for physical simulation of robots, games, visual effects and machine learning.

As an optional implementation, in step S22, an operation of converting the first three-dimensional movement trajectory into the second three-dimensional movement trajectory includes the following steps.

At step S221, multiple first vertexes on the target contact surface are projected to a display plane, to obtain multiple second vertexes. Multiple sets of matching point pairs are formed by the multiple first vertexes and the multiple second vertexes.

At step S222, a camera internal parameter matrix corresponding to the camera space is acquired.

At step S223, a camera external parameter matrix corresponding to the camera space is acquired by means of the camera internal parameter matrix and the multiple sets of matching point pairs.

At step S224, the first three-dimensional movement trajectory is converted into the second three-dimensional movement trajectory based on the camera external parameter matrix.

The display plane may be a two-dimensional image that displays the target contact surface in the initial video shot by the camera. The multiple first vertexes on the target contact surface are projected to the display plane, to obtain the multiple second vertexes. The multiple first vertexes are vertexes of an area corresponding to the target contact surface in the world space. The multiple second vertexes are vertexes of an area corresponding to the target contact surface in the camera space. Each of the multiple first vertexes corresponds to each of the multiple second vertexes. That is, multiple sets of matching point pairs are formed by the multiple first vertexes and the multiple second vertexes.

The camera internal parameter matrix may be a matrix that is composed of multiple parameters of the camera in the camera space. The multiple parameters may include a focal length of the camera, an optical center location of the camera, or the like. The camera external parameter matrix may be a matrix that is composed of multiple other parameters of the camera in the camera space. The multiple other parameters may include attitude parameters such as rotation parameters and translation parameters. The camera external parameter matrix may be acquired by means of the camera internal parameter matrix and the multiple sets of matching point pairs.

The first three-dimensional movement trajectory may be converted into the second three-dimensional movement trajectory based on the camera external parameter matrix. The first three-dimensional movement trajectory is the three-dimensional movement trajectory of the virtual three-dimensional model in the world space. The second three-dimensional movement trajectory is a three-dimensional movement trajectory of the virtual three-dimensional model in the camera space.

As an optional implementation, in step S222, an operation of acquiring the camera internal parameter matrix corresponding to the camera space includes the following steps.

At step S2221, size information of the display plane is acquired.

At step S2222, an optical center location corresponding to the camera space is calculated by means of the size information.

At step S2223, the camera internal parameter matrix is determined based on the optical center location corresponding to the camera space and a preset focal length.

The display plane may be a two-dimensional image that displays the target contact surface in the initial video shot by the camera. The size information of the display plane may be a geometric size of the two-dimensional image, such as, a length, a width, or the like.

The optical center location may be a central point location of a convex lens of the camera, and the camera is a camera that takes the initial video. The size information of the display plane is acquired. Then, the optical center location corresponding to the camera space may be calculated by means of the size information.

A preset focal length is determined according to an actual situation of the camera shooting the initial video. The camera internal parameter matrix may be determined according to the optical center location corresponding to the camera space and the preset focal length.

Still as shown in FIG. 3, in the live streaming Live1, the four vertexes A, B, C, and D of the table surface tablet in the world space are projected to the two-dimensional graphical user interface. The vertex A is projected to obtain A′, the vertex B is projected to obtain B′, the vertex C is projected to obtain C′, and the vertex D is projected to obtain D′. In this way, four sets of matching point pairs (A, A′), (B, B′), (C, C′), and (D, D′) are obtained.

A length H and a width W of a quadrilateral A′B′C′D′ obtained by projecting the table surface tablet to the two-dimensional graphical user interface are acquired. The optical center location (cx, cy) of the live streaming camera in the camera space is determined according to the length H and the width W of the quadrilateral A′B′C′D′, where cx=W/2, cy=H/2. A focal length of the live streaming camera is determined as a preset value f. The camera internal parameter matrix is determined based on the optical center location (cx, cy) of the live streaming camera in the camera space and the preset focal length f, which is recorded as the following.

$${T}_{internal} = ( \begin{matrix}f & 0 & cx \\ 0 & f & cy \\ 0 & 0 & 1\end{matrix} )$$

The camera external parameter matrix Textrinsic [RT, −RTT] corresponding to the camera space is estimated according to the camera internal parameter matrix Tinternal and the four sets of matching point pairs (A, A′), (B, B′), (C, C′), and (D, D′), where R is a rotation matrix in a camera attitude parameter, RT is the transposition of R, and T is a translation matrix in the camera attitude parameter.

Optionally, the estimation process may be implemented according to a Perspective-n-Point (PNP) algorithm. The PNP algorithm is used for estimating the attitude parameter of the camera in a specific coordinate system in a case that n three-dimensional space point coordinates corresponding to the specific coordinate system and two-dimensional projection locations of the n three-dimensional space point coordinates have already know.

Still as shown in FIG. 4, in the live streaming Live1, three-dimensional effect display of a marble gift B1 delivered by an audience is taken as an example. The three-dimensional movement trajectory Tworld of the marble gift B1 in the world space is transformed into the three-dimensional movement trajectory Tcamera in the camera space according to the external parameter matrix Textrinsic of the camera. The transformation process is implemented through the following operations. For each point on Tworld, a coordinate Xworld of this point in the world space coordinate system is acquired. Then the Xworld in the world coordinate system is multiplied with the external parameter matrix Textrinsic of the camera, to obtain a coordinate Xcamera of this point in the camera space coordinate system. That is, Xcamera=TextrinsicXworld.

As an optional implementation, in step S24, an operation of determining the movement sequence of the virtual three-dimensional model in the camera space according to the second three-dimensional movement trajectory includes the following steps.

At step S241, a first coordinate location of the virtual three-dimensional model in the world space is transformed to a second coordinate location in the camera space.

At step S242, the movement sequence is determined by means of the second coordinate location and the second three-dimensional movement trajectory.

The first three-dimensional movement trajectory may include at least one coordinate location of the virtual three-dimensional model in the world space, that is, at least one first coordinate location. The at least one second coordinate location of the virtual three-dimensional model in the camera space may be transformed based on the at least one first coordinate location of the virtual three-dimensional model in the world space.

The movement sequence of the virtual three-dimensional model in the camera space may be determined based on the at least one second coordinate location of the virtual three-dimensional model in the camera space and the second three-dimensional movement trajectory.

Still as shown in FIG. 4, in the live streaming Live1, three-dimensional effect display of a marble gift B1 delivered by an audience is taken as an example. The coordinate Xworld of the marble gift B1 in the world space coordinate system is acquired according to the three-dimensional movement trajectory Tworld of the marble gift B1 in the world space. Xworld is transformed to Xcamera according to the external parameter matrix Textrinsic of the camera. The movement sequence Mcamera of the marble gift B1 in the camera space may be determined by means of the location coordinate Xcamera of the marble gift B1 in the camera space and the three-dimensional movement trajectory Tcamera.

As an optional implementation, in step S26, an operation of compositing the virtual three-dimensional model and the initial video by means of the texture information of the virtual three-dimensional model and the movement sequence, to obtain the to-be-played target video includes the following steps.

At step S261, a two-dimensional video corresponding to the virtual three-dimensional model and a target display area are rendered by means of the texture information and the movement sequence.

At step S262, the two-dimensional video and the initial video are composited in the target display area, to obtain the to-be-played target video.

The two-dimensional video corresponding to the virtual three-dimensional model may be configured to display the movement of the virtual three-dimensional model to audiences. The target display area may be a display area corresponding to the movement of the virtual three-dimensional model in the initial video shot by the camera, and may be configured to composite the two-dimensional video and the initial video. The two-dimensional video corresponding to the virtual three-dimensional model and the target display area may be rendered by means of the texture information of the virtual three-dimensional model and the movement sequence of the virtual three-dimensional model in the camera space.

In the target display area corresponding to the initial video shot by the camera, the two-dimensional video corresponding to the virtual three-dimensional model and the initial video shot by the camera are composited to obtain the to-be-played target video. The to-be-played target video is a video including the three-dimensional movement effect of the virtual three-dimensional model.

Still as shown in FIG. 4, in the live streaming Live1, three-dimensional effect display of a marble gift B1 delivered by an audience is taken as an example. A two-dimensional video Video1 corresponding to the three-dimensional movement effect of the marble gift B1 may be rendered according to the texture information U and the movement sequence M camera of the marble gift B1 in the camera space. In addition, a display area Q of the three-dimensional movement effect of the marble gift B1 in the initial video Video may be further rendered.

Optionally, the rendering process may be implemented according to an Open Graphics Library (OpenGL). OpenGL is a cross-language or cross-platform application programming interface configured to render two-dimensional or three-dimensional vector graphics, which is often used for computer-aided design, VR, scientific visualization programs, and video game development.

In the display area Q corresponding to the initial video Video, the two-dimensional video Video1 corresponding to the three-dimensional movement effect of the marble gift B1 is superimposed with the initial video Video to obtain the video #Video configured to be played for the audiences. #Video is a live streaming video including the three-dimensional movement effect of the marble gift B1.

Optionally, the superimposition process is implemented according to an Alpha Matting algorithm. The Alpha Matting algorithm is a method for separating foreground information in an image from background information, which may also be used for superimposing the foreground information and the background information. This algorithm is widely applied to the field of video editing and video segmentation.

From the above descriptions about the implementation modes, those skilled in the art may clearly know that the method according to the foregoing embodiments may be implemented in a manner of combining software and a necessary universal hardware platform, and of course, may also be implemented through hardware, but the former is an optional implementation mode under many circumstances. Based on such an understanding, the technical solutions of the present disclosure substantially or parts making contributions to the conventional art may be embodied in form of a software product, and the computer software product is stored in a storage medium, including multiple instructions for causing a terminal device (which may be a mobile phone, a computer, a server, a network device or the like) to execute the method in each embodiment of the present disclosure.

The present disclosure further provides an apparatus for processing a video. The apparatus is configured to implement the foregoing embodiments and the optional implementation, and what has been described will not be described again. As used below, the term “module” may be a combination of software and/or hardware that implements a predetermined function. Although the apparatus described in the following embodiments is exemplary implemented in software, but implementations in hardware, or a combination of software and hardware, are also possible and conceived.

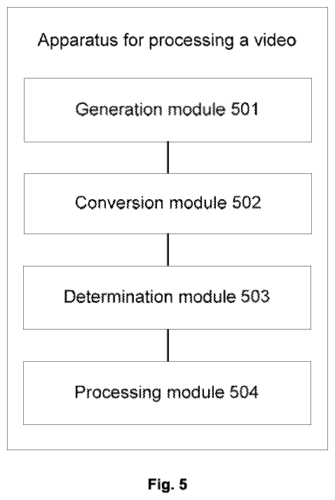

FIG. 5 is a structural block diagram of an apparatus for processing a video according to an embodiment of the present disclosure. As shown in FIG. 5, the apparatus 500 for processing a video includes a generation module 501, a conversion module 502, a determination module 503, and a processing module 504.

The generation module 501 is configured to generate a first three-dimensional movement trajectory of a virtual three-dimensional model in world space based on attribute information of a target contact surface of the virtual three-dimensional model in the world space. The conversion module 502 is configured to convert the first three-dimensional movement trajectory into a second three-dimensional movement trajectory in camera space. The camera space is three-dimensional space for shooting an initial video. The determination module 503 is configured to determine a movement sequence of the virtual three-dimensional model in the camera space according to the second three-dimensional movement trajectory. The processing module 504 is configured to composite the virtual three-dimensional model and the initial video by means of texture information of the virtual three-dimensional model and the movement sequence, to obtain a to-be-played target video.

Optionally, the generation module 501 is further configured to: determine location information of the target contact surface in the world space according to world coordinates of multiple first vertexes on the target contact surface in the world space; and generate the first three-dimensional movement trajectory based on the location information and quality information of the virtual three-dimensional model.

Optionally, the generation module 501 is further configured to: configure an initial location of the virtual three-dimensional model in the world space based on the location information and the quality information of the virtual three-dimensional model; and acquire the first three-dimensional movement trajectory formed by the virtual three-dimensional model falling from the initial location to the target contact surface and rebounding under a reaction force of the target contact surface through a preset physics engine.

Optionally, the conversion module 502 is further configured to: project multiple first vertexes on the target contact surface to a display plane, to obtain multiple second vertexes, where multiple sets of matching point pairs are formed by the multiple first vertexes and the multiple second vertexes; acquire a camera internal parameter matrix corresponding to the camera space; acquire a camera external parameter matrix corresponding to the camera space by means of the camera internal parameter matrix and the multiple sets of matching point pairs; and convert the first three-dimensional movement trajectory into the second three-dimensional movement trajectory based on the camera external parameter matrix.

Optionally, the conversion module 502 is further configured to: acquire size information of the display plane; calculate an optical center location corresponding to the camera space by means of the size information; and determine the camera internal parameter matrix based on the optical center location corresponding to the camera space and a preset focal length.

Optionally, the determination module 503 is further configured to: transform a first coordinate location of the virtual three-dimensional model in the world space to a second coordinate location in the camera space; and determine the movement sequence by means of the second coordinate location and the second three-dimensional movement trajectory.

Optionally, the processing module 504 is further configured to: render a two-dimensional video corresponding to the virtual three-dimensional model and a target display area by means of the texture information and the movement sequence; and composite the two-dimensional video and the initial video in the target display area, to obtain the to-be-played target video.

It is to be noted that, each of the above modules may be implemented by software or hardware. For the latter, it may be implemented in the following manners, but is not limited to the follow: the above modules are all located in a same processor; or the above modules are located in different processors in any combination.

An embodiment of the present disclosure further provides an electronic device. The electronic device includes a memory and at least one processor. The memory is configured to store at least one computer instruction. The processor is configured to run the at least one computer instruction to perform steps in any one of method embodiments described above.

Optionally, the electronic device may further include a transmission device and an input/output device. The transmission device is connected with the processor. The input/output device is connected with the processor.

Optionally, in this embodiment, the processor may be configured to perform the following steps through the computer program.

At step S1, a first three-dimensional movement trajectory of a virtual three-dimensional model in world space is generated based on attribute information of a target contact surface of the virtual three-dimensional model in the world space.

At step S2, the first three-dimensional movement trajectory is converted into a second three-dimensional movement trajectory in camera space. The camera space is three-dimensional space for shooting an initial video.

At step S3, a movement sequence of the virtual three-dimensional model in the camera space is determined according to the second three-dimensional movement trajectory.

At step S4, the virtual three-dimensional model and the initial video are composited by means of texture information of the virtual three-dimensional model and the movement sequence, to obtain a to-be-played target video.

Optionally, for specific examples in this embodiment, refer to the examples described in the foregoing embodiments and the optional implementations, and this embodiment will not be repeated thereto.

An embodiment of the present disclosure further provides a non-transitory computer-readable storage medium storing at least one computer instruction. The non-transitory computer-readable storage medium stores at least one computer instruction. Steps in any one of the method embodiments described above are performed when the at least one computer instruction is run.

Optionally, in this embodiment, the non-transitory computer-readable storage medium may be configured to store a computer program for performing the following steps.

At step S1, a first three-dimensional movement trajectory of a virtual three-dimensional model in world space is generated based on attribute information of a target contact surface of the virtual three-dimensional model in the world space.

At step S2, the first three-dimensional movement trajectory is converted into a second three-dimensional movement trajectory in camera space. The camera space is three-dimensional space for shooting an initial video.

At step S3, a movement sequence of the virtual three-dimensional model in the camera space is determined according to the second three-dimensional movement trajectory.

At step S4, the virtual three-dimensional model and the initial video are composited by means of texture information of the virtual three-dimensional model and the movement sequence, to obtain a to-be-played target video.

Optionally, in this embodiment, the non-transitory computer-readable storage medium may include, but is not limited to, a USB flash disk, a Read-Only Memory (ROM), a Random Access Memory (RAM), and various media that can store computer programs, such as a mobile hard disk, a magnetic disk, or an optical disk.

An embodiment of the present disclosure further provides a computer program product. Program codes used for implementing the method for processing a video of the present disclosure can be written in any combination of at least one programming language. These program codes can be provided to the processors or controllers of general computers, special computers, or other programmable data processing devices, so that, when the program codes are performed by the processors or controllers, functions/operations specified in the flowcharts and/or block diagrams are implemented. The program codes can be performed entirely on a machine, partially performed on the machine, and partially performed on the machine and partially performed on a remote machine as an independent software package, or entirely performed on the remote machine or a server.

The serial numbers of the foregoing embodiments of the present disclosure are for description, and do not represent the superiority or inferiority of the embodiments.

In the above embodiments of the present disclosure, the description of the embodiments has its own focus. For parts that are not described in detail in a certain embodiment, reference may be made to related descriptions of other embodiments.

In the several embodiments provided in the present disclosure, it should be understood that, the disclosed technical content can be implemented in other ways. The apparatus embodiments described above are illustrative. For example, the division of the units may be a logical function division, and there may be other divisions in actual implementation. For example, multiple units or components may be combined or integrated into another system, or some features can be ignored, or not implemented. In addition, the displayed or discussed mutual coupling or direct coupling or communication connection may be indirect coupling or communication connection through some interfaces, units or modules, and may be in electrical or other forms.

The units described as separate components may or may not be physically separated. The components displayed as units may or may not be physical units, that is, the components may be located in one place, or may be distributed on the multiple units. Part or all of the units may be selected according to actual requirements to achieve the purposes of the solutions of this embodiment.

In addition, the functional units in the various embodiments of the present disclosure may be integrated into one processing unit, or each unit may exist alone physically, or at least two units may be integrated into one unit. The above integrated unit can be implemented in the form of hardware, or can be implemented in the form of a software functional unit.

If the integrated unit is implemented in the form of the software functional unit and sold or used as an independent product, it can be stored in the computer readable storage medium. Based on this understanding, the technical solutions of the present disclosure essentially or the parts that contribute to the related art, or all or part of the technical solutions can be embodied in the form of a software product. The computer software product is stored in a storage medium, including multiple instructions for causing a computer device (which may be a personal computer, a server, or a network device, and the like) to execute all or part of the steps of the method described in the various embodiments of the present disclosure. The foregoing storage medium includes a USB flash disk, a Read-Only Memory (ROM), a Random Access Memory (RAM), and various media that can store program codes, such as a mobile hard disk, a magnetic disk, or an optical disk.

The above description are exemplary implementations of the present disclosure, and it should be noted that persons of ordinary skill in the art may also make several improvements and refinements without departing from the principle of the present disclosure, and it should be considered that these improvements and refinements shall all fall within the protection scope of the present disclosure.

What is claimed is:

1. A method for processing a video, comprising:
generating a first three-dimensional movement trajectory of a virtual three-dimensional model in world space based on attribute information of a target contact surface of the virtual three-dimensional model in the world space;
converting the first three-dimensional movement trajectory into a second three-dimensional movement trajectory in camera space, wherein the camera space is three-dimensional space for shooting an initial video;
determining a movement sequence of the virtual three-dimensional model in the camera space according to the second three-dimensional movement trajectory; and
compositing the virtual three-dimensional model and the initial video by means of texture information of the virtual three-dimensional model and the movement sequence, to obtain a to-be-played target video.

2. The method as claimed in claim 1, wherein generating the first three-dimensional movement trajectory based on the attribute information of the target contact surface comprises:
determining location information of the target contact surface in the world space according to world coordinates of a plurality of first vertexes on the target contact surface in the world space; and
generating the first three-dimensional movement trajectory based on the location information and quality information of the virtual three-dimensional model.

3. The method as claimed in claim 2, wherein generating the first three-dimensional movement trajectory based on the location information and the quality information of the virtual three-dimensional model comprises:
configuring an initial location of the virtual three-dimensional model in the world space based on the location information and the quality information of the virtual three-dimensional model; and
acquiring the first three-dimensional movement trajectory formed by the virtual three-dimensional model falling from the initial location to the target contact surface and rebounding under a reaction force of the target contact surface through a preset physics engine.

4. The method as claimed in claim 1, wherein converting the first three-dimensional movement trajectory into the second three-dimensional movement trajectory comprises:
projecting a plurality of first vertexes on the target contact surface to a display plane, to obtain a plurality of second vertexes, wherein a plurality of sets of matching point pairs are formed by the plurality of first vertexes and the plurality of second vertexes;
acquiring a camera internal parameter matrix corresponding to the camera space;
acquiring a camera external parameter matrix corresponding to the camera space by means of the camera internal parameter matrix and the plurality of sets of matching point pairs; and
converting the first three-dimensional movement trajectory into the second three-dimensional movement trajectory based on the camera external parameter matrix.

5. The method as claimed in claim 4, wherein acquiring the camera internal parameter matrix corresponding to the camera space comprises:
acquiring size information of the display plane;
calculating an optical center location corresponding to the camera space by means of the size information; and
determining the camera internal parameter matrix based on the optical center location corresponding to the camera space and a preset focal length.

6. The method as claimed in claim 1, wherein determining the movement sequence of the virtual three-dimensional model in the camera space according to the second three-dimensional movement trajectory comprises:
transforming a first coordinate location of the virtual three-dimensional model in the world space to a second coordinate location in the camera space; and
determining the movement sequence by means of the second coordinate location and the second three-dimensional movement trajectory.

7. The method as claimed in claim 1, wherein compositing the virtual three-dimensional model and the initial video by means of the texture information and the movement sequence, to obtain the to-be-played target video comprises:
rendering a two-dimensional video corresponding to the virtual three-dimensional model and a target display area by means of the texture information and the movement sequence; and
compositing the two-dimensional video and the initial video in the target display area, to obtain the to-be-played target video.

8. An electronic device, comprising:
at least one processor, and
a memory, communicatively connected with the at least one processor, wherein
the memory is configured to store at least one instruction executable by the at least one processor, and the at least one instruction is performed by the at least one processor, to cause the at least one processor to perform the following steps:
generating a first three-dimensional movement trajectory of a virtual three-dimensional model in world space based on attribute information of a target contact surface of the virtual three-dimensional model in the world space;
converting the first three-dimensional movement trajectory into a second three-dimensional movement trajectory in camera space, wherein the camera space is three-dimensional space for shooting an initial video;
determining a movement sequence of the virtual three-dimensional model in the camera space according to the second three-dimensional movement trajectory; and
compositing the virtual three-dimensional model and the initial video by means of texture information of the virtual three-dimensional model and the movement sequence, to obtain a to-be-played target video.

9. The electronic device as claimed in claim 8, wherein generating the first three-dimensional movement trajectory based on the attribute information of the target contact surface comprises:
determining location information of the target contact surface in the world space according to world coordinates of a plurality of first vertexes on the target contact surface in the world space; and
generating the first three-dimensional movement trajectory based on the location information and quality information of the virtual three-dimensional model.

10. The electronic device as claimed in claim 9, wherein generating the first three-dimensional movement trajectory based on the location information and the quality information of the virtual three-dimensional model comprises:
configuring an initial location of the virtual three-dimensional model in the world space based on the location information and the quality information of the virtual three-dimensional model; and
acquiring the first three-dimensional movement trajectory formed by the virtual three-dimensional model falling from the initial location to the target contact surface and rebounding under a reaction force of the target contact surface through a preset physics engine.

11. The electronic device as claimed in claim 8, wherein converting the first three-dimensional movement trajectory into the second three-dimensional movement trajectory comprises:
projecting a plurality of first vertexes on the target contact surface to a display plane, to obtain a plurality of second vertexes, wherein a plurality of sets of matching point pairs are formed by the plurality of first vertexes and the plurality of second vertexes;
acquiring a camera internal parameter matrix corresponding to the camera space;
acquiring a camera external parameter matrix corresponding to the camera space by means of the camera internal parameter matrix and the plurality of sets of matching point pairs; and
converting the first three-dimensional movement trajectory into the second three-dimensional movement trajectory based on the camera external parameter matrix.

12. The electronic device as claimed in claim 11, wherein acquiring the camera internal parameter matrix corresponding to the camera space comprises:
acquiring size information of the display plane;
calculating an optical center location corresponding to the camera space by means of the size information; and
determining the camera internal parameter matrix based on the optical center location corresponding to the camera space and a preset focal length.

13. The electronic device as claimed in claim 8, wherein determining the movement sequence of the virtual three-dimensional model in the camera space according to the second three-dimensional movement trajectory comprises:
transforming a first coordinate location of the virtual three-dimensional model in the world space to a second coordinate location in the camera space; and
determining the movement sequence by means of the second coordinate location and the second three-dimensional movement trajectory.

14. The electronic device as claimed in claim 8, wherein compositing the virtual three-dimensional model and the initial video by means of the texture information and the movement sequence, to obtain the to-be-played target video comprises:
rendering a two-dimensional video corresponding to the virtual three-dimensional model and a target display area by means of the texture information and the movement sequence; and
compositing the two-dimensional video and the initial video in the target display area, to obtain the to-be-played target video.

15. A non-transitory computer readable storage medium, storing at least one computer instruction, wherein the at least one computer instruction is used for a computer to perform the following steps:
generating a first three-dimensional movement trajectory of a virtual three-dimensional model in world space based on attribute information of a target contact surface of the virtual three-dimensional model in the world space;
converting the first three-dimensional movement trajectory into a second three-dimensional movement trajectory in camera space, wherein the camera space is three-dimensional space for shooting an initial video;
determining a movement sequence of the virtual three-dimensional model in the camera space according to the second three-dimensional movement trajectory; and
compositing the virtual three-dimensional model and the initial video by means of texture information of the virtual three-dimensional model and the movement sequence, to obtain a to-be-played target video.

16. The non-transitory computer readable storage medium as claimed in claim 15, wherein generating the first three-dimensional movement trajectory based on the attribute information of the target contact surface comprises:
determining location information of the target contact surface in the world space according to world coordinates of a plurality of first vertexes on the target contact surface in the world space; and
generating the first three-dimensional movement trajectory based on the location information and quality information of the virtual three-dimensional model.

17. The non-transitory computer readable storage medium as claimed in claim 16, wherein generating the first three-dimensional movement trajectory based on the location information and the quality information of the virtual three-dimensional model comprises:
configuring an initial location of the virtual three-dimensional model in the world space based on the location information and the quality information of the virtual three-dimensional model; and
acquiring the first three-dimensional movement trajectory formed by the virtual three-dimensional model falling from the initial location to the target contact surface and rebounding under a reaction force of the target contact surface through a preset physics engine.

18. The non-transitory computer readable storage medium as claimed in claim 15, wherein converting the first three-dimensional movement trajectory into the second three-dimensional movement trajectory comprises:
projecting a plurality of first vertexes on the target contact surface to a display plane, to obtain a plurality of second vertexes, wherein a plurality of sets of matching point pairs are formed by the plurality of first vertexes and the plurality of second vertexes;
acquiring a camera internal parameter matrix corresponding to the camera space;
acquiring a camera external parameter matrix corresponding to the camera space by means of the camera internal parameter matrix and the plurality of sets of matching point pairs; and
converting the first three-dimensional movement trajectory into the second three-dimensional movement trajectory based on the camera external parameter matrix.

19. The non-transitory computer readable storage medium as claimed in claim 15, wherein determining the movement sequence of the virtual three-dimensional model in the camera space according to the second three-dimensional movement trajectory comprises:
transforming a first coordinate location of the virtual three-dimensional model in the world space to a second coordinate location in the camera space; and
determining the movement sequence by means of the second coordinate location and the second three-dimensional movement trajectory.

20. The non-transitory computer readable storage medium as claimed in claim 15, wherein compositing the virtual three-dimensional model and the initial video by means of the texture information and the movement sequence, to obtain the to-be-played target video comprises:
rendering a two-dimensional video corresponding to the virtual three-dimensional model and a target display area by means of the texture information and the movement sequence; and
compositing the two-dimensional video and the initial video in the target display area, to obtain the to-be-played target video.
